(19) United States
(12) Patent Application Publication
(10) Pub. No.: US 2015/0241285 A1
(43) Pub. Date: Aug. 27, 2015

(54) SYSTEMS AND METHODS FOR A TEMPERATURE MONITORING DEVICE

(71) Applicant: Amphenol Thermometrics, Inc., Saint Marys, PA (US)

(72) Inventors: Shane Timothy Schneider, St. Mary's, PA (US); Jason John Detsch, St. Mary's, PA (US); Mark Anthony Denovellis, North Billerica, MA (US); Volker Friedrich Luebcke, Vaihingen/Enz (DE); Derrick Kirton, Baltimore, MD (US); Daniel Zimmerman, Billerica, MA (US); Daniel James Gongloff, Ridgway, PA (US)

(21) Appl. No.: 14/192,844

(22) Filed: Feb. 27, 2014

(51) Int. Cl. G01K 1/08; G01K 7/16; G01K 7/02

(52) U.S. Cl. CPC G01K 1/08; G01K 7/02; G01K 7/16

(57) ABSTRACT

The subject matter disclosed herein relates to temperature monitoring devices, and more specifically to surface temperature monitoring devices (e.g., surface temperature loggers, surface temperature sensors, surface thermal probes). In an embodiment, a system includes a temperature monitoring device configured to measure a temperature of a surface. The temperature monitoring device includes a housing and a thermal sensor disposed in the housing. The temperature monitoring device also includes a thermal pad disposed on a measurement face of the housing, wherein the thermal pad is configured to provide a high-thermal conductivity path between the surface and the temperature monitoring device.

### BACKGROUND

The subject matter disclosed herein relates to temperature monitoring devices, and more specifically to surface temperature monitoring devices (e.g., surface temperature loggers, surface temperature sensors, and surface thermal probes).

Temperature monitoring devices, such as temperature loggers and temperature sensors, may be used to monitor temperatures within a system. That is, temperature monitoring devices may be used to collect and store temperature measurements for a particular portion of a monitored system over a period of time. For example, a temperature logger may function to collect and store air temperature measurements for a particular room of an office building over the course of a day. Temperature monitoring devices may be used to investigate the thermal properties of the monitored system, such as the heat capacity of certain components of the system, heat transfer between certain components of the system, competing heat transfer paths in the system, energy loses due to heat transfer within the system, temperature stability of the system, and so forth. As such, temperature monitoring devices may be used to collect temperature measurement data that may be used, for example, to control operation of the monitored system, to verify proper operation of the monitored system for quality control purposes, and to determine how the monitored system may be modified or reengineered to improve the thermal efficiency of the system.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, a system includes a temperature monitoring device configured to measure a temperature of a surface. The temperature monitoring device includes a housing and a thermal sensor disposed in the housing. The temperature monitoring device also includes a thermal pad disposed on a measurement face of the housing, wherein the thermal pad is configured to provide a high-thermal conductivity path between the surface and the temperature monitoring device.

In another embodiment, a method includes disposing a thermal pad between a temperature monitoring device and a surface, wherein the thermal pad is in thermal contact with the temperature monitoring device and with the surface. The method includes reducing a pressure at the surface about the temperature monitoring device and periodically collecting temperature measurements of the surface using the temperature monitoring device.

In another embodiment, a method includes disposing a temperature monitoring device onto a surface to be monitored, wherein a thermal pad is disposed between the temperature monitoring device and the surface. The method further includes measuring and recording a temperature of the surface using a thermal sensor of a temperature monitoring device.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of a temperature monitoring device;

FIG. 2 is a partially exploded perspective view of an embodiment of a temperature monitoring device (e.g., a temperature logger) and a monitored surface;

FIG. 3 is a perspective view of an embodiment in which a plurality of temperature loggers are disposed within a freeze drying device; and

FIG. 4 is a cross-sectional view of an embodiment of the temperature logger illustrated in FIG. 2, illustrating the temperature logger disposed on a monitored surface; and

FIG. 5 is a schematic view of an embodiment a control system having a plurality of temperature monitoring devices (e.g., temperature sensors) configured to monitor temperatures of an oven unit under reduced pressure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As set forth above, temperature monitoring devices may be used to investigate the thermal properties of a monitored system. Certain types of temperature monitoring devices, referred to herein as temperature loggers, may collect and store temperature measurement data over a period of time in an internal memory for later analysis. For example, a temperature logger in a pharmaceutical manufacturing facility may collect temperature measurement data for a freeze drier during operation in order to verify proper operation of the freeze drier (e.g., for quality control purposes) during the manufacture of a pharmaceutical product. Other types of temperature monitoring devices, referred to herein as temperature sensors, may also include communication circuitry to provide temperature measurements to other devices during operation of the monitored system. For example, one or more temperature sensors may be used in industrial control systems (e.g., gas turbine systems, wind turbine systems, steam turbine systems, hydraulic turbine system, power plants, petroleum refining systems, chemical production system, pharmaceutical manufacturing systems, and so forth) to collect temperature measurement data that may be used by a controller to determine how to control operation of the system. By specific example, a temperature monitoring device may collect temperature measurement data that may be used by a controller of a gas turbine system to determine the operational temperature of a particular component (e.g., a compressor inlet) such that the controller may provide control signals to one or more components (e.g., compressor inlet guide vanes) of the gas turbine system to modify the operation of the gas turbine system in response to the collected temperature measurements.

As such, it may be appreciated that temperature monitoring devices, such as temperature sensors and temperature loggers, may operate to collect temperature data in a number of different types of environments. For example, certain temperature monitoring devices, such as surface temperature loggers and surface temperature sensors, may be configured for measuring the temperature of a solid surface as opposed to measuring the temperature of a fluid, such as air or water. Additionally, temperature monitoring devices may operate over a range of temperatures, which may be generally limited by the nature of certain internal components (e.g., a battery, sensing circuitry, and so forth) of each temperature monitoring device. For example, certain temperature monitoring devices may operate to collect temperature measurement at cryogenic temperatures (e.g., between approximately 0° C. and approximately −100° C., between approximately −10° C. and approximately −90° C., or between approximately −20° C. and approximately −85° C.), or at relatively higher temperatures (e.g., between approximately 0° C. and approximately 160° C., between approximately 20° C. and approximately 150° C., or between approximately 50° C. and 140° C.), or may operate over a wide temperature window (e.g., between approximately −100° C. and approximately 160° C., between approximately −90° C. and approximately 150° C., or between approximately −85° C. and approximately 140° C.).

Further, certain temperature monitoring devices may also operate to collect temperature measurements in reduced pressure environments (e.g., under vacuum). For surface temperature monitoring devices, performing temperature measurements in a reduced pressure environment offers particular challenges. For example, without the disclose embodiments, the surface of the temperature monitoring device may be disposed directly against the surface for temperature monitoring. As such, any non-uniformity (e.g., surface defect, manufacturing variation or irregularity) in the surface of the packaging of the temperature monitoring device and/or in the monitored surface may yield a gap (e.g., an air gap) between the temperature monitoring device and the monitored surface. Since the thermal conductivity of the gas (e.g., air) in these gaps may be significantly less than the thermal conductivity of the packaging of the temperature monitoring device and the monitored surface, these gaps affect the accuracy of the temperature measurements collected by the temperature monitoring device. Furthermore, under reduced pressure, this problem is exacerbated as the gas disposed inside these gaps may be replaced with vacuum (e.g., a void), which may be an even poorer conductor of thermal energy. Accordingly, without the disclosed embodiments, the accuracy of the temperature measurements collected by a surface temperature monitoring device may be substantially affected by the nature of the contact (e.g., surface contact, thermal contact) between the packaging of the temperature monitoring device and the monitored surface.

With the foregoing in mind, present embodiments are directed toward surface temperature monitoring devices, such as surface temperature loggers and surface temperature sensors, which enable an improved surface contact between the surface temperature monitoring device and the monitored surface. As set forth in detail below, the presently disclosed temperature monitoring devices include a thermal pad (e.g., an elastomeric polymer pad) that is disposed between the surface temperature monitoring device and the monitored surface. As discussed below, in certain embodiments, this thermal pad may be a polymer that may or may not be impregnated with other materials (e.g., metallic micro- or nanoparticles) to endow the thermal pad with a high thermal conductivity. Accordingly, this high thermal conductivity enables a relatively uniform heat transfer between the surface of the temperature monitoring device and the monitored surface. For example, the thermal pad may expand into the surface defects in the packaging of the temperature monitoring device and the monitored surface such that air gaps (under atmospheric pressure) or void gaps (under reduced pressure) are not present. As such, the presently disclosed temperature monitoring devices enable improved accuracy and thermal response for the collected temperature measurement data, especially for measurements performed in reduced pressure environments. Additionally, in certain embodiments, the disclosed thermal pad may be reusable, which may provide advantages in terms of cost and environmental impact. Accordingly, the disclosed thermal pad may be useful for temperature sensors (e.g., in a control system environment), temperature loggers (e.g., for quality control in a manufacturing environment), or any other suitable temperature monitoring device to enable improved accuracy and thermal response.

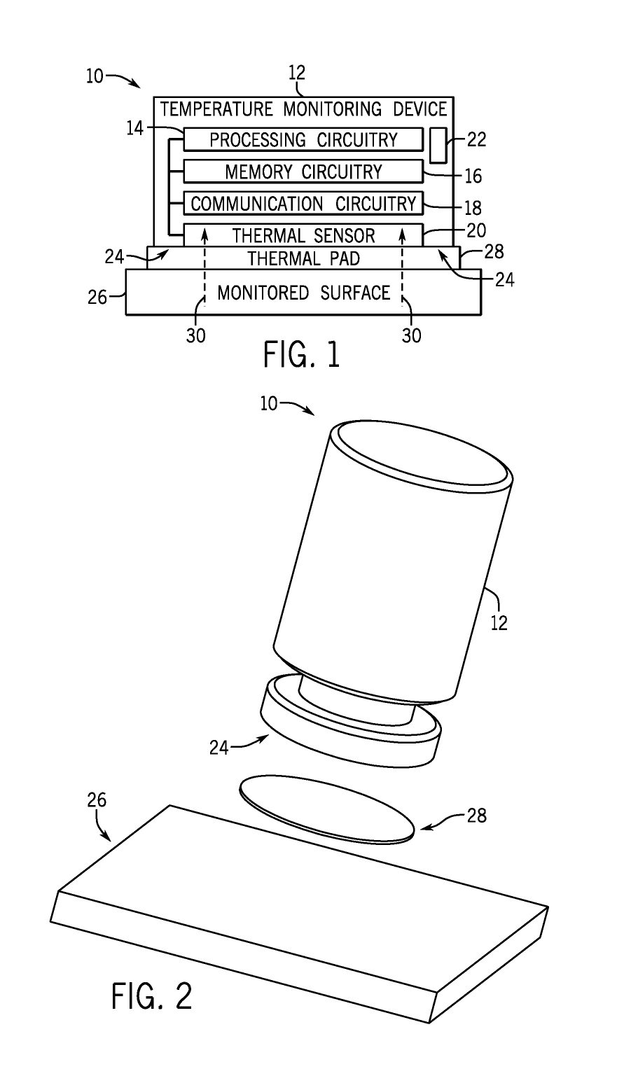

FIG. 1 is a schematic illustrating an embodiment of a temperature monitoring device 10. In particular, the temperature monitoring device 10 illustrated in FIG. 1 may be a surface temperature sensor 10. As such, the surface temperature sensor 10 includes a packaging 12 (e.g., a hermetically sealed housing) that houses the internal components of the surface temperature sensor 10. The packaging 12 may be any suitable thermally conductive packaging (e.g., metallic, polymeric, ceramic, or composite packaging). By specific example, in certain embodiments, the packaging 12 may be made from stainless steel. The illustrated packaging 12 encloses the internal circuitry of the temperature monitoring device 10. For the illustrated embodiment, the temperature monitoring device 10 includes processing circuitry 14, memory circuitry 16, communication circuitry 18, thermal sensor 20, and power source 22. The processing circuitry 14 may be a general purpose central processing unit (CPU) (e.g., a complex instruction set computer (CISC) processor or a reduced instruction set computer (RISC), or may be a specialized processor (e.g., field-programmable gate array (FPGA) or application-specific integrated circuit (ASIC)), capable of executing instructions (e.g., firmware) stored in the memory circuitry 16. The illustrated memory circuitry 16 may include random access memory (RAM), flash memory, electrically erasable programmable read-only memory (EEPROM), a hard drive, a solid-state disk, or a combination thereof. The illustrated communication circuitry 18 may include a network interface card (NIC) that may enable the temperature monitoring device 10 to communicate temperature measurement data to another device, such as a controller of an industrial control or monitoring system, via a wired or wireless communication network. In other embodiments, such as embodiments in which the temperature monitoring device 10 is a temperature logger, the temperature measurements collected by the thermal sensor 20 may be stored in the memory circuitry 16 for later access (e.g., when the temperature logger is loaded into a docking station), which may be facilitated by the communication circuitry 18. The power source 22 may be a battery (e.g., a lithium ion battery, a nickel metal hydride battery, or another suitable battery), a capacitor or capacitor bank, or another suitable power source 22. In certain embodiments, the temperature monitoring device 10 may be coupled to an external power source (e.g., a power outlet) and may therefore lack the internal power source 22.

The illustrated thermal sensor 20 is disposed directly against the packaging 12 on the measurement face 24 (e.g., the mounting interface) of the temperature monitoring device 10. In other embodiments, the thermal sensor 20 may be separated from the packaging 20 by one or more layers having a high thermal conductivity. In still other embodiments, only the measurement face 24 of the housing 12 of the temperature monitoring device 10 may be thermally conductive to enable efficient thermal transfer to the thermal sensor 20. Regardless, the thermal sensor 20 may generally be in thermal contact or thermal communication with the measurement face 24 of the temperature monitoring device 10. In certain embodiments, the thermal sensor 20 may be a resistance temperature detector (RTD), a thermocouple, a thermistor, or any other suitable electronic thermal measurement device. During operation of the illustrated temperature monitoring device 10, the processing circuitry 14 may execute one or more instructions stored within the memory circuitry 16 to cause the thermal sensor 20 to perform a temperature measurement, and the processing circuitry 14 may then collect and store the measurement in the memory circuitry 16. The temperature measurement performed at the measurement face 24 of the temperature monitoring device 10 is representative of the temperature of the monitored surface 26. That is, as discussed below, the thermal pad 28 may generally provide a low resistance thermal pathway, such that the temperature at the measurement face 24 of the temperature monitoring device 10 is approximately the same as the temperature of the monitored surface 26, even as the temperature of the monitored surface 26 quickly changes, improving the thermal responsiveness of the temperature monitoring device 10.

The illustrated temperature monitoring device 10 may be capable of operating in different measurement environments. For example, temperature monitoring device 10 may operate at temperatures between approximately −85° C. and approximately 140° C. and at humidities between 0% and 100%. Additionally, the temperature monitoring device 10 is capable of operation at higher pressures (e.g., 10 bar) and at very low pressures (e.g., <1 millibar, approximately 0 millibar, at nearly perfect vacuum). In certain embodiments, the packaging 12 temperature monitoring device 10 may be hermetically sealed and the communication circuitry 18 may enable temperature measurement data stored in the memory circuitry 16 to be extracted from the temperature monitoring device 10 (e.g., via radio frequency communication or via inductive communication with a docking station via the packaging 12). In certain embodiments, the temperature monitoring device 10 may be capable of performing temperature measurements at a sampling rate between approximately one hundred measurements per second to approximately one measurement per twelve hours, including any suitable sub-range therein. Additionally, in certain embodiments, the temperature monitoring device 10 may be capable of storing at least 1,000, 10,000, 100,000, or more temperature measurements in the memory circuitry 16, along with metadata indicating, for example, when each temperature measurement was performed. In other embodiments, the temperature monitoring device 10 may additionally include circuitry to facilitate the measurement of other parameters (e.g., humidity, pressure, gas flow rates, gas composition, etc.) for storage along with the temperature measurement data.

In order to facilitate efficient thermal transfer between the temperature monitoring device 10 and the monitored surface 26, the temperature monitoring device 10 includes a thermal pad 28 that is disposed between the measurement face 24 of the temperature monitoring device 10 and the monitored surface 26. As mentioned above, the thermal pad 28 may be an elastomeric material that may enable improved surface contact and/or thermal contact between the temperature monitoring device 10 and the monitored surface 26. That is, the thermal pad 28 may expand into any irregularities in the surface of the measurement face 24 of the temperature monitoring device 10 and/or the monitored surface 26 to provide continuous surface contact and a low-resistance thermal barrier (e.g., good thermal conductivity at the interface). Further, the thermal pad 28 may provide a high thermal conductivity path 30 (e.g., a low thermal resistance path) between the measurement face 24 of the temperature monitoring device 10 and the monitored surface 26. For example, in certain embodiments, the thermal pad 28 may provide a thermal conductivity greater than approximately 1 Watt per meter-Kelvin (W/mK), greater than approximately 2 W/mK, greater than approximately 2.5 W/mK, greater than approximately 3 W/mK, between approximately 1 W/mK and approximately 5 W/mK, between approximately 2 W/mK and approximately 4 W/mK, or between approximately 2.5 W/mK and approximately 3.5 W/mK.

In certain embodiments, the thermal pad 28 may be an elastomer, such as a silicone or acrylic elastomer. By way of example, the thermal pad 28 may be a Sil-Pad®, such as the Sil-Pad® A2000 or Sil-Pad® 2000 available from the Bergquist Company of Chanhassen, Minn. Such elastomers may provide a high thermal conductivity (e.g., greater than 1 W/mK, greater than 1.5 W/mK, greater than 2 W/mK, greater than 2.5 W/mK, or approximately 3 W/mK) path 30 such that the measurement face 24 of the temperature monitoring device 10 is in good thermal contact or communication with the monitored surface 26. Further, in certain embodiments, these elastomers may be grease-free and may readily conform to surfaces and surface irregularities. Additionally, in certain embodiments, the thermal pad 28 may be adhered to the measurement surface 24 of the temperature monitoring device 10, may be adhered to the monitored surface 26, or both, using one or more adhesives (e.g., silicone adhesives, acrylic adhesives, glues, epoxies, resins, or other suitable adhesives). In particular, in certain embodiments, acrylic adhesives may enable a longer shelf life (e.g., 6 months longer) for the thermal pad 28 than other adhesives (e.g., silicone adhesives).

In certain embodiments, the thermal pad may be flat, curved, or shaped with any geometry to conform to the measurement face 24 of the temperature monitoring device 10, the monitored surface 26, or both. Additionally, as discussed in detail below, in certain embodiments the thermal pad 28 may be reusable. It may be noted that, while certain elastomers (e.g., silicone elastomers) may also be electrically insulating, the thermal pad 28 may be electrically conductive in certain embodiments without negating the effect of the present approach. As mentioned above and discussed in detail below, the thermal pad 28 is especially advantageous for embodiments in which the temperature monitoring device 10 is collecting temperature measurements from the monitored surface 26 in a reduced pressure environment (e.g., under a vacuum) by maintaining continuous thermal contact or communication between the measurement face 24 of the temperature monitoring device 10 and the monitored surface 26.

FIG. 2 is a partially exploded perspective view of an embodiment of the temperature monitoring device 10, the thermal pad 28, and the monitored surface 26. The temperature monitoring device 10 illustrated in FIG. 2 is a temperature logger 10. As such, the illustrated temperature logger 10 may be designed to be disposed on the monitored surface 26 prior to performing the temperature measurements, and designed to be removed from the monitored surface 26 after performing the temperature measurements. After removal, the temperature logger 10 may be subsequently loaded into a docking station, such that the temperature measurement data may be read from the memory circuitry 16 of the temperature logger 10. As such, in certain embodiments, the temperature logger 10 may be regularly (e.g., once per week, once per day, twice per day, after each operation of a piece of equipment that includes the monitored surface 26) disposed on, as well as removed from, the monitored surface 26.

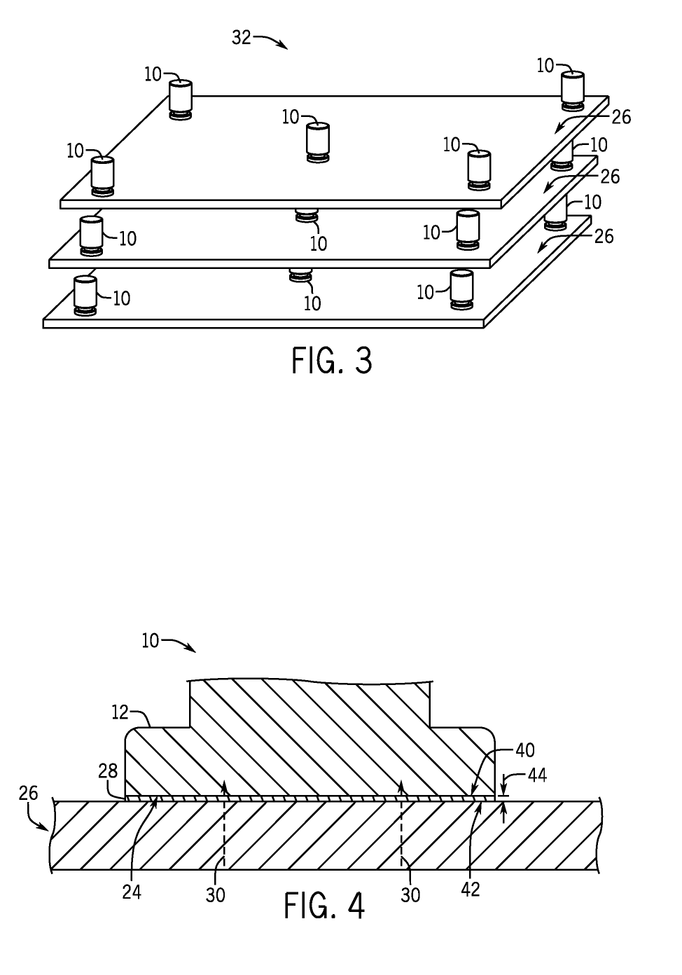

For example, the monitored surface 26 may be a stainless steel shelf 26 of a freeze drying device of a pharmaceutical manufacturing facility. Turning briefly to FIG. 3, a plurality of temperature logger embodiments 10 are illustrated as being disposed on monitored surfaces 26 of a freeze drying device 32. That is, the freeze drying device 32 illustrated in FIG. 3 includes three shelves 26, wherein each of the three shelves 26 include five temperature loggers 10. As such, the freeze drying device 32 illustrated in FIG. 3 may represent a system in which temperature measurements are to be collected from five different locations on each shelf 26 throughout an operation of the freeze drying device 32. It may be appreciated that other embodiments may include any number of shelves (e.g., 1, 2, 3, 4, 5, 6, 7, 8, 9, 10 or more shelves) and may include any number of temperature loggers 10 (e.g., between 1 and 10 temperature loggers per shelf, between 2 and 8 temperature loggers per shelf, or between 3 and 5 temperature loggers per shelf). During the manufacture of a particular pharmaceutical product, it may be desirable to monitor a temperature of the shelf 26 using the temperature logger 10 throughout each operation of the freeze drying device in order to satisfy regulatory guidelines (e.g., Food and Drug Administration (FDA) guidelines) and/or enable enhanced quality control.

As such, turning back to FIG. 2, for each operation of the freeze drying device, the temperature logger 10 may be assembled by first disposing the thermal pad 28 against the measurement face 24 of the temperature logger 10 before the temperature logger 10 is disposed on the shelf 26. In certain embodiments, the thermal pad 28 may be first disposed on the shelf 26, and temperature logger 10 may subsequently be assembled by disposing the packaging 12 on top of the thermal pad 28. In certain embodiments, the thermal pad 28 may be adhered to the measurement face 24 of the temperature logger 10 and/or the shelf 26 using glue, an epoxy, a resin, or another suitable adhesive material. However, in certain embodiments, the thermal pad 28 may be disposed between the measurement face 24 of the temperature logger 10 and the shelf 26 without the use of adhesives or thermal compounds (e.g., thermal grease or thermal paste). It should be appreciated that such embodiments enable easier installation and removal of the temperature logger 10 (e.g., less application and cleaning time) between each operation of the freeze drying device and/or enable fewer potential contaminants from being introduced into the freeze drying device via the adhesives or thermal compounds. It should also be appreciated that certain embodiments of the thermal pad 28 may be reusable or recyclable, meaning that the thermal pad 28 may be applied to, removed from, and subsequently reapplied to the measurement face 24 of the temperature logger 10 for another measurement operation. In certain embodiments, the thermal pad 28 may be capable of being reused between 1 and approximately 30 times, between approximately 5 and approximately 25 times, between approximately 10 and approximately 20 times, or approximately 15 times.

FIG. 4 is a cross-sectional view of the embodiment of the temperature logger 10 illustrated in FIG. 2 when it is disposed on the monitored surface 26. As such, a first side 40 of the thermal pad 28 is disposed along the measurement face 24 of the packaging 12 of temperature logger 10 and expands into any irregularities in the measurement face 24 of the temperature logger 10 to provide a good, continuous surface contact. Additionally, a second side 42 of the thermal pad 28 is disposed along the monitored surface 26 and expands into any irregularities in the monitored surface 26 to provide a continuous surface contact. As such, the thermal pad 28 provides a high thermal conductivity path 30 (e.g., a low thermal impedance or resistance path 30) between the monitored surface 26 and the measurement face 24 of the temperature logger 10. Additionally, as illustrated in FIG. 4, the thermal pad 28 has a thickness 44 that may range between approximately 0.2 millimeters (mm) and approximately 2 mm, between approximately 0.4 mm and approximately 1 mm, or between approximately 0.35 mm and approximately 0.5 mm. For example, in certain embodiments, the thermal pad 28 may have a thickness 44 of approximately 0.2 mm, approximately 0.3 mm, approximately 0.35 mm, approximately 0.4 mm, approximately 0.45 mm, or approximately 0.5 mm. In certain embodiments, the thickness 44 of the thermal pad 28 may not substantially change when the temperature logger 10 is placed in a reduced pressure atmosphere. Further, in certain embodiments, the thermal pad 28 may be sized to exactly match the dimensions of the measurement face 24 of the temperature logger 10, while in other embodiments, the thermal pad 28 may be slightly larger or smaller than the measurement face 24 of the temperature logger 10. Additionally, it may be appreciated that the thermal pad 28 may be somewhat compressed (e.g., pressed down) as the temperature monitoring device 10 is installed or mounted on to the monitored surface 26, and this compressive force may generally facilitate the expansion of the thermal pad 28 into the surface irregularities of the measurement face 24 of the temperature monitoring device 10 and/or the monitored surface 26 during mounting.

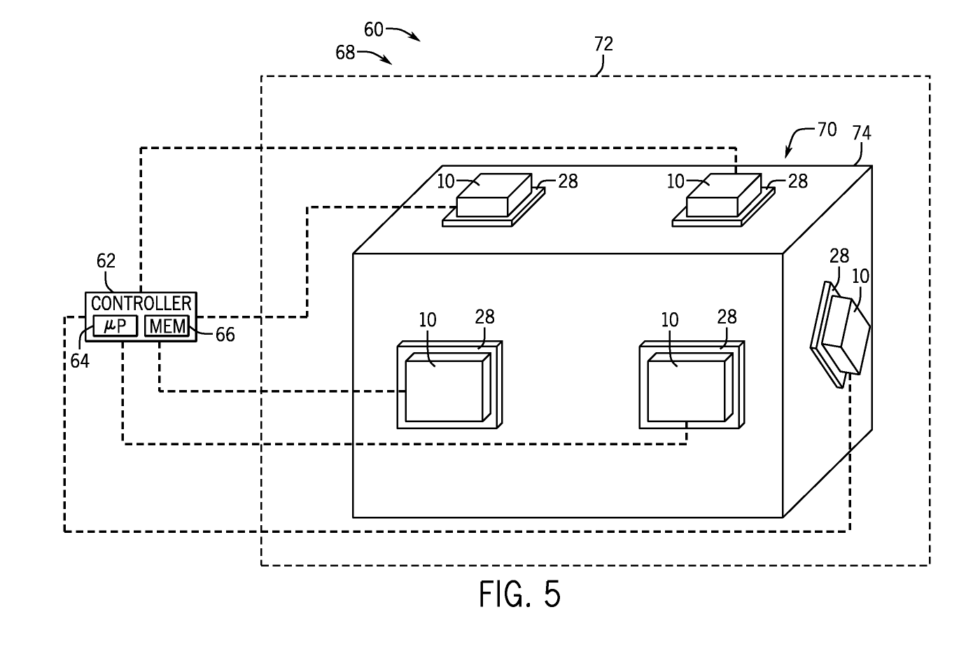

FIG. 5 is a schematic view of a portion of a control system 60. In certain embodiments, the control system 60 may be part of, for example, a turbine system, a petrochemical refining system, a chemical production system, a pharmaceutical manufacturing system, or another suitable control system. The portion of the control system 60 illustrated in FIG. 5 includes a controller 62 having a processor 64 that is configured to execute instructions stored in the memory 66 to control operation of the control system 60. In general, the processor 64 of the controller 62 may be communicatively coupled to a number of devices, including temperature monitoring devices 10, distributed throughout the control system 60 that may provide monitoring information to the controller 62. The illustrated control system 60 includes a vacuum oven system 68, in which an oven unit 70 is operated at elevated temperature (e.g., 120° C.) and within a reduced pressure environment 72.

The vacuum oven system 68 includes a number of surface temperature sensors 10, in accordance with an embodiment of the present approach, disposed against a surface 74 (e.g., an outer surface 74) of the oven unit 70. Each surface temperature sensor 10 is communicatively coupled to the controller 62 via a wired or wireless communication interface provided by the communication circuitry 18 discussed above. Additionally, each of the surface temperature sensors 10 has a thermal pad 28 disposed between the surface temperature sensor 10 and the outer surface 74 of the oven unit 70. As set forth above, the thermal pad 28 enables improved surface and/or thermal contact between the surface temperature sensors 10 and the surface 74 of the oven unit 70. As such, even within the reduced pressure environment 72, the surface temperature sensors 10 are in continuous thermal contact (e.g., thermal equilibrium) with the outer surface 74 of the oven unit 70.

Technical effects of the invention include providing an improved surface contact and thermal contact between a surface temperature monitoring device (e.g., a surface temperature logger or surface temperature sensor) and the surface whose temperature is being monitored via the use of a thermal pad. This thermal pad may expand to occupy surface defects (e.g., manufacturing variation or irregularity) in the measurement face of the temperature monitoring device as well as the monitored surface. As such, the thermal pad prevents the occurrence of gaps (e.g., air gaps under atmospheric pressure, voids under reduced pressure) that can create a thermal barrier between the temperature monitoring device and the monitored surface. Therefore, the presently disclosed surface temperature monitoring devices enable the collection of more accurate temperature measurements for the monitored surface as well as a better thermal response time for the temperature measurement device as the temperature of the monitored surface changes over time. These advantages may be applicable to any temperature measurement device, including temperature sensors of a control system and stand-alone temperature loggers.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a temperature monitoring device configured to measure a temperature of a surface, wherein the temperature monitoring device comprises:
a housing;
a thermal sensor disposed in the housing; and
a thermal pad disposed on a measurement face of the housing, wherein the thermal pad is configured to provide a high-thermal conductivity path between the surface and the temperature monitoring device.

2. The system of claim 1, wherein the thermal pad comprises a silicone elastomer.

3. The system of claim 1, wherein the thermal pad has a thickness between approximately 0.2 millimeters (mm) and approximately 2 mm.

4. The system of claim 1, wherein the thermal pad is removable and reusable to mount the temperature monitoring device to the surface a plurality of times.

5. The system of claim 1, wherein the high-thermal conductivity path has a thermal conductivity of at least approximately 1 watts per meter Kelvin (W/m-K).

6. The system of claim 1, wherein the housing of the temperature monitoring device comprises stainless steel.

7. The system of claim 1, wherein the thermal sensor comprises a resistance temperature detector (RTD) or a thermocouple.

8. The system of claim 1, wherein the temperature monitoring device comprises a processor and a memory disposed inside the housing, wherein the processor is configured to execute instructions stored in the memory to measure the temperature of the surface and to store the measured temperature in the memory.

9. A method, comprising:
disposing a thermal pad between a temperature monitoring device and a surface, wherein the thermal pad is in thermal contact with the temperature monitoring device and with the surface;
reducing a pressure at the surface about the temperature monitoring device; and
periodically collecting temperature measurements of the surface using the temperature monitoring device.

10. The method of claim 9, wherein the thermal pad has a thickness between approximately 0.35 mm and approximately 0.5 mm.

11. The method of claim 9, wherein disposing the thermal pad between the temperature monitoring device and the surface comprises compressing the thermal pad between the temperature monitoring device and the surface such that the thermal pad expands in surface defects of the temperature monitoring device, the surface, or both, to provide continuous thermal contact between the temperature monitoring device and the surface.

12. The method of claim 9, wherein the surface is disposed on a freeze drying device.

13. The method of claim 9, wherein the thermal pad has a thermal conductivity greater than approximately 1 watt per meter Kelvin (W/m-K).

14. The method of claim 9, wherein reducing the pressure at the surface comprises reducing the pressure to between approximately 10 millibar and approximately 0 millibar.

15. The method of claim 9, comprising reducing a temperature of the surface to between approximately 0° C. and approximately −85° C.

16. The method of claim 9, comprising reporting the collected measurements to a control or monitoring device via a network connection.

17. The method of claim 9, comprising removing the temperature monitoring device from the surface and placing the temperature monitoring device in a docking station to read the collected temperature measurements from the temperature monitoring device.

18. A method, comprising:
disposing a temperature monitoring device onto a surface to be monitored, wherein a thermal pad is disposed between the temperature monitoring device and the surface; and
measuring and recording a temperature of the surface using a thermal sensor of a temperature monitoring device.

19. The method of claim 18, comprising adhering the thermal pad against a measurement face of a thermally conductive housing of the temperature monitoring device using a silicone or acrylic adhesive.

20. The method of claim 18, comprising altering the temperature of the surface to be between approximately −85° C. and approximately 140° C. and applying a vacuum at the surface to provide a pressure between approximately 10 millibar and approximately 0 millibar.
